(19) United States
(12) Patent Application Publication
(10) Pub. No.: US 2004/0028356 A1
(43) Pub. Date: Feb. 12, 2004

(54) Nonlinear optical device

(76) Inventors: Timothy Birks, Bath (GB); William John Wadsworth, Bath (GB); Philip St. John Russell, Bath (GB)

Correspondence Address: FOGG AND ASSOCIATES, LLC, P.O. BOX 581339, MINNEAPOLIS, MN, 55458-1339, US

(21) Appl. No.: 10/275,455

(22) PCT Filed: May 3, 2001
(86) PCT No.: PCT/GB01/01947

(30) Foreign Application Priority Data
May 5, 2000 (GB) 0010950.4

(51) Int. Cl. G02B 6/00; G02B 6/26

(52) U.S. Cl. 385/122; 385/43

(57) ABSTRACT

A nonlinear optical device, comprises a source of input light having a first spectrum and an optical fibre 10 arranged so that in use the light propagates through the fibre 10, the optical fibre 10 comprises a tapered region including a waist 30, the waist 30 having a diameter smaller than 10 microns for a length of more than 20 mm, wherein the propagating light is converted by nonlinear optical processes into output light having a spectrum different from the first spectrum.

This invention relates to the field of nonlinear optical devices.

Conventional sources of broadband (“white”) light such as an incandescent bulb are very weak, providing little power per unit solid angle per nanometer of bandwidth. More powerful sources generally have narrow bandwidths; for example, an erbium-doped fibre fluorescence source (such as an erbium amplifier without an input wave or a laser without mirrors) emits over a bandwidth only as wide as the emission spectrum of erbium (approximately 1480 nm to 1580 nm).

High-power broadband sources have applications in fields such as spectroscopy (particularly ultrafast pump-probe spectroscopy) and dispersion measurement.

Generation of high-power, broad-band light, known as “supercontinuum generation” (or “white-light continuum generation” or simply “continuum generation”) has been demonstrated in optical fibres using high-power pump sources. Maxim S. Pshenichnikov et al. (Opt. Lett. 19, 572 (1994)) describe such a supercontinuum-generation device. In that device, an argon-ion mainframe laser is used to pump a self-modelocked Ti:sapphire laser. A cavity-dumping scheme is used to extract intracavity pulses of high energy. In Pshenichnikov's demonstration of supercontinuum-generation, 13 fs pulses of 40 nJ were injected into a 3-mm length of polarisation preserving fibre. Pulses having a bandwidth of between 500 nm and 1000 nm were produced.

Supercontinuum generation in a conventional step-index optical fibre such as that used by Pshenichnikov thus requires high peak-power pulses. Recently, however, supercontinuum-generation has been demonstrated with much lower peak-power pulses by the use of a special form of fibre, the “microstructured”, “holey” or “photonic crystal” fibre (PCF). Such fibres comprise a plurality of longitudinal holes in a bulk fibre material, the holes being arranged to form a cladding region surrounding a core region. Waveguiding in such fibres is achievable by two methods. Firstly, if the “effective” refractive index of the cladding region (that is, the refractive index resulting from the combined effects of the holes and the bulk material in the cladding region) is smaller than the refractive index of the core, then waveguiding can take place through total-internal reflection at the core-cladding boundary. Secondly, if the holes are arranged in an appropriate periodic structure, the cladding can exhibit photonic band gaps and light of a wavelength within the bandgap can propagate only at the core, which acts as a defect in the periodic structure.

The demonstration of supercontinuum generation in a microstructured fibre is reported in Jinendra K. Ranka et al., Opt. Lett. 25, 25 (2000). Ranka uses 100-fs pulses with peak powers of only 8 kW (0.8 nJ energy) to generate an ultra-broadband continuum extending from 390 nm to 1600 nm from a 75-cm length of microstructured fibre.

However, the microstructured fibre is a complex device and it requires particular expertise and facilities for its design and fabrication. Furthermore, microstructured fibres are not at present generally commercially available.

A good guide to nonlinear optical effects in standard fibres is the textbook “Nonlinear Fiber Optics”, 2^{nd} Edn. Govind P. Agrawal, Academic Press, 1995.

An object of the invention is to provide a nonlinear optical device that overcomes problems such as those associated with prior art devices described above.

According to the invention there is provided a nonlinear optical device, comprising a source of input light having a first spectrum and an optical fibre arranged so that in use the light propagates through the fibre, the optical fibre comprising a tapered region including a waist, the waist having a diameter smaller than 10 μm for a length of more than 20 mm, wherein the propagating light is converted by nonlinear optical processes into output light having a spectrum different from the first spectrum.

Also according to the invention there is provided a method of generating nonlinear optical effects comprising propagating input light having a first spectrum through an optical fibre, the optical fibre having a tapered region including a waist, the waist having a diameter smaller than 10 μm for a length of more than 20 mm, wherein the propagating light is converted by nonlinear optical processes into output light having a spectrum different from the first spectrum.

Also according to the invention there is provided an optical fibre comprising a tapered region including a waist, the waist having a diameter smaller than 10 μm for a length of more than 20 mm and, wherein, in use, the propagating light is converted by nonlinear optical processes into output light having a spectrum different from the first spectrum.

An advantage of the invention is that it enables nonlinear optical effects such as supercontinuum generation to be effected at low input powers in a device manufactured from a standard fibre. Tapering fibres is a very well-known technique that requires only readily available equipment. Use of standard fibres results in direct compatibility with many existing fibre, and indeed free-space, systems.

Another advantage of the invention is that light may be input into a non-tapered portion of the fibre; that makes coupling of input light into the fibre much more straightforward than in the case of, for example, the microstructured fibre described above, in which it is necessary to introduce light into a core region of diameter approximately 1.7 μm.

The changes to the first spectrum may be in amplitude and/or phase.

Preferably, the waist has a diameter smaller than the diameter at which the net group-velocity dispersion D experienced by input light at a wavelength of 850 nm is greater than −40 ps nm⁻¹ km⁻¹.

Group-velocity dispersion (GVD) is defined as parameter D, where

$$D = \frac{ⅆ}{ⅆ λ} ( \frac{1}{{v}_{g}} ) ,$$

where λ is the centre wavelength and v_{g} is the group velocity of the light at λ. The net GVD is taken to be the combined effect of the GVD resulting from propagation through the material of which the fibre is made and the GVD resulting from the shape of the tapered region.

Preferably, the waist has a diameter smaller than the diameter at which the net group-velocity dispersion D that would be experienced by light at a wavelength within ±100 nm of the centre wavelength of the input light is anomalous. Dispersion is anomalous when D is positive. More preferably, the waist has a diameter smaller than the diameter at which the net group-velocity dispersion D experienced by light at the centre wavelength of the input light is anomalous.

The net group-velocity dispersion experienced by light propagating in the fibre depends on parameters such as the fibre material, the waist diameter and the wavelength of the light. A fibre that would be expected to exhibit normal dispersion at a particular wavelength can in some cases be made to exhibit anomalous dispersion at that wavelength by the provision of a waist of sufficiently small diameter (note, however, that a waists of very small diameter may not support a propagating mode). The possibility of providing anomalous dispersion is particularly important in pulsed systems because pulses propagating under dispersion generally broaden in time, weakening nonlinear effects. However, propagation under anomalous dispersion can lead to pulse shortening and thus enhance nonlinear effects such as supercontinuum generation.

Preferably, the output spectrum has a width of at least 50 nm at 30 dB down from its maximum power. Advantageously, the output light has a still wider spectrum; thus, ever more preferable upper limits are 100 nm, 200 nm, 300 nm, 500 nm, 700 nm and 1000 nm at 30 dB, or preferably at 20 dB, or more preferably at 10 dB down from its maximum power.

Preferably, the waist has a length of more than 30 mm. A longer waist will in general result in an enhanced nonlinear effect. Thus ever more preferable lower limits are 50 mm, 80 mm and 150 mm.

The diameter of the waist may be less than 7 μm, 5 μm, 3.5 μm, 3 μm, 2.5 μm or 2 μm. Preferably, the waist is of substantially uniform diameter over its length. Alternatively, the diameter of the waist may vary along its length; in that case, the diameters given above are maximum diameters within the waist region.

Preferably, the diameter of the waist does not exceed twice its minimum value over its length. More preferably, the diameter of the waist does not exceed 1.5 times, 1.2 times, 1.1 times or 1.05 times its minimum value over its length.

Preferably, the power of the input light is greater than 10 W. A higher input power will in general result in a stronger nonlinear effect. Thus ever more preferable lower limits are 30 W, 100 W, 300 W, 1 kW, 3 kW, 10 kW or 30 kW. Of course, undesirable thermo-mechanical damage may occur in some systems at very high powers, particularly for continuous-wave input light.

Preferably, the input light is pulsed; in that case, the power referred to above is the peak power of the pulses. Preferably the pulses are shorter than 10 ps. Shorter pulse lengths will in general result in a stronger nonlinear effect. Thus ever more preferable upper limits are 3 ps, 1 ps, 300 fs, 100 fs, 30 fs or 10 fs.

Preferably, the input light comes from a source of input light that is a laser. The laser may be a Ti:sapphire laser. The laser may be modelocked.

Preferably, the fibre is a standard fibre (that is, not a microstructured fibre). Alternatively, the fibre may be microstructured.

Preferably, the fibre comprises fused silica. Preferably, the fibre is single mode at a wavelength within the spectrum of the output light. More preferably, the fibre is single mode at all wavelengths of the output light. Preferably, the fibre is single mode at the centre wavelength of the input light. More preferably, the fibre is single mode at all wavelengths of the input light.

The fibre may be fixed in a package at points along its length outside the tapered region. Such packaging is preferable in practice as it helps to prevent dust, which can cause catastrophic damage, from reaching the fibre.

The fibre may be surrounded, at least at the tapered region, by air. Alternatively, the fibre may be surrounded, at least at the tapered region, by a fluid other than air; that may be advantageous as a means to promote non-linear effects or to modify the dispersion characteristics of the taper. Alternatively, the fibre may be surrounded, at least at the tapered region, by a vacuum.

A second fibre may be fused to the fibre. Further fibres may be fused to the fibre and/or the second fibre.

The fused fibres may form a fused coupler. The fibres may be substantially identical so that the fused coupler is symmetric. Alternatively, at least one of the fibres may be dissimilar from at least one other fibre in the coupler so that the coupler is asymmetric. The dissimilar fibre may be so dissimilar that the coupler is a null coupler in which preferably less than 2% of the light is split over a wide wavelength range. An output of the coupler could be used to monitor the coupler's behaviour in use. A null coupler in which specific higher order modes are excited in the fused waist may have different and advantageous optical properties.

A tapered region may be provided in the fibre by heating and stretching, by chemical etching, by polishing or by any other suitable means.

Also according to the invention there is provided a method of supercontinuum generation, comprising propagating input light having a first spectrum through an optical fibre, the optical fibre having a tapered region including a waist, the waist having a diameter smaller than 10 μm, wherein the propagating light is converted by nonlinear optical processes into output light having an output spectrum having a width of at least 300 μm at 30 dB down from its maximum power.

An embodiment of the invention will now be described, by way of example only, with reference to the accompanying drawings, of which:

FIG. 1 is a schematic diagram of a tapered optical fibre according to the invention;

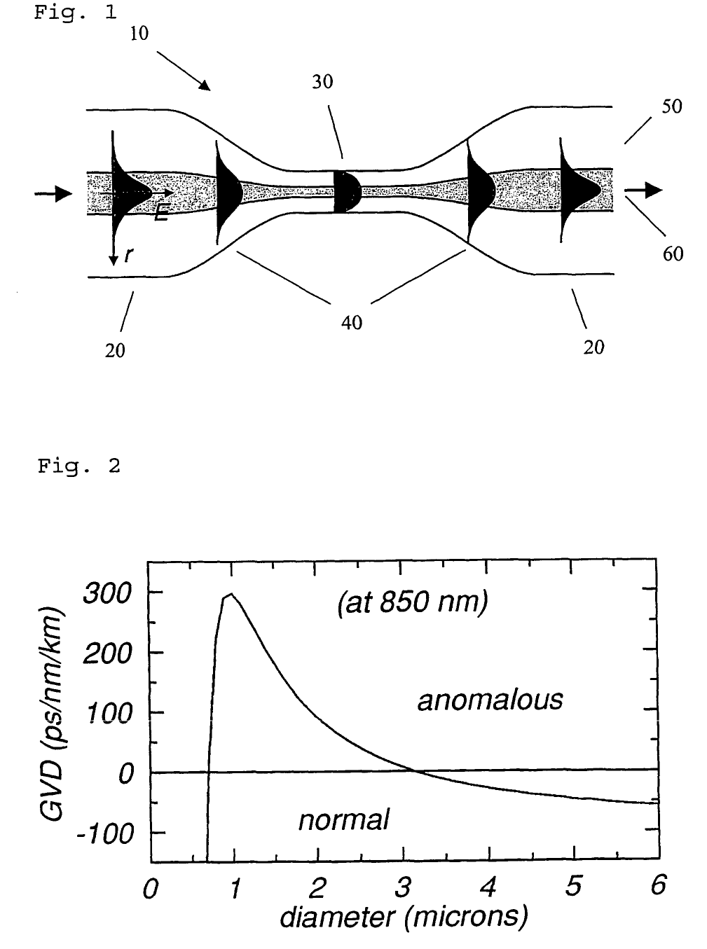

FIG. 2 shows the variation of net group-velocity dispersion (GVD) with waist diameter for the waist of a tapered silica fibre, at a wavelength of 850 nm;

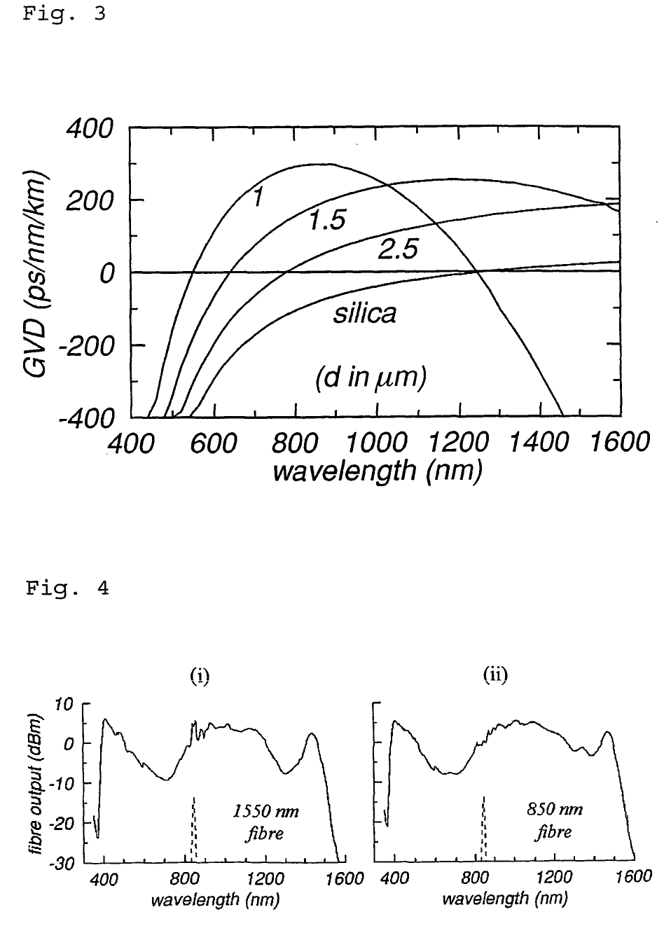

FIG. 3 shows the variation of net group-velocity dispersion (GVD) with wavelength for a tapered silica fibre of waist diameter of 1 μm, 1.5 μm and 2.5 μm, and also for bulk silica;

FIG. 4 shows output spectra obtained from tapered (i) telecomms fibre designed for use at 1550 nm and (ii) 850 nm single-mode fibre; the broken line represents the input laser spectrum, scaled vertically for comparison;

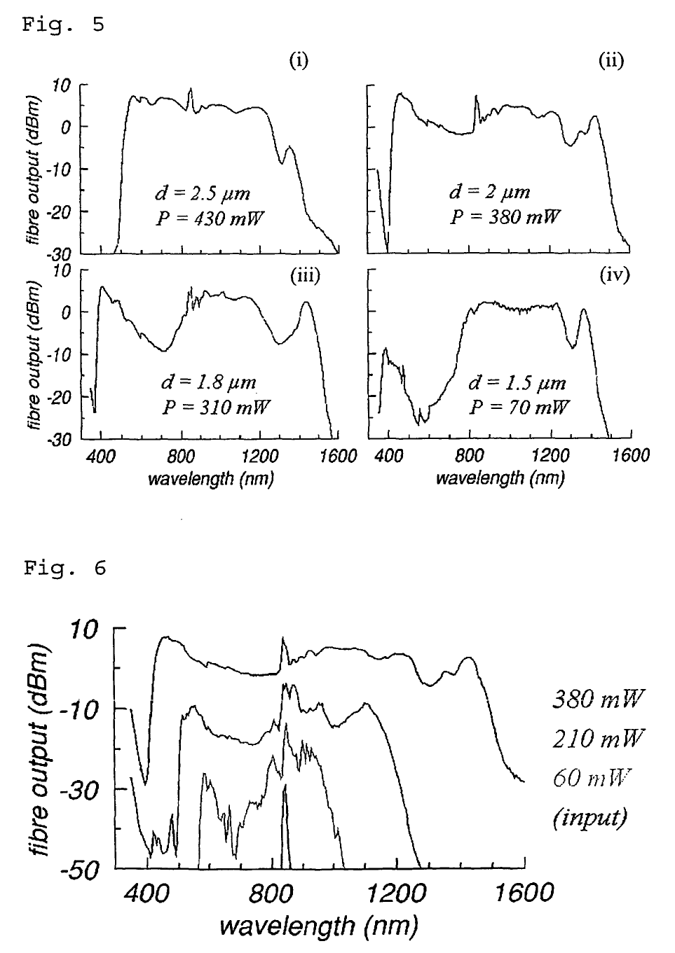

FIG. 5 shows output spectra obtained from tapered fibres of diameters (i) 2.5 μm and (ii) 2 μm (iii) 1.8 μm (iv) 1.5 μm for pulse energies of 5.7 nJ, 5.0 nJ, 4.1 nJ and 0.9 nJ respectively;

FIG. 6 shows output spectra obtained from the tapered fibre for different output powers: 380 mW, 210 mW and 60 mW;

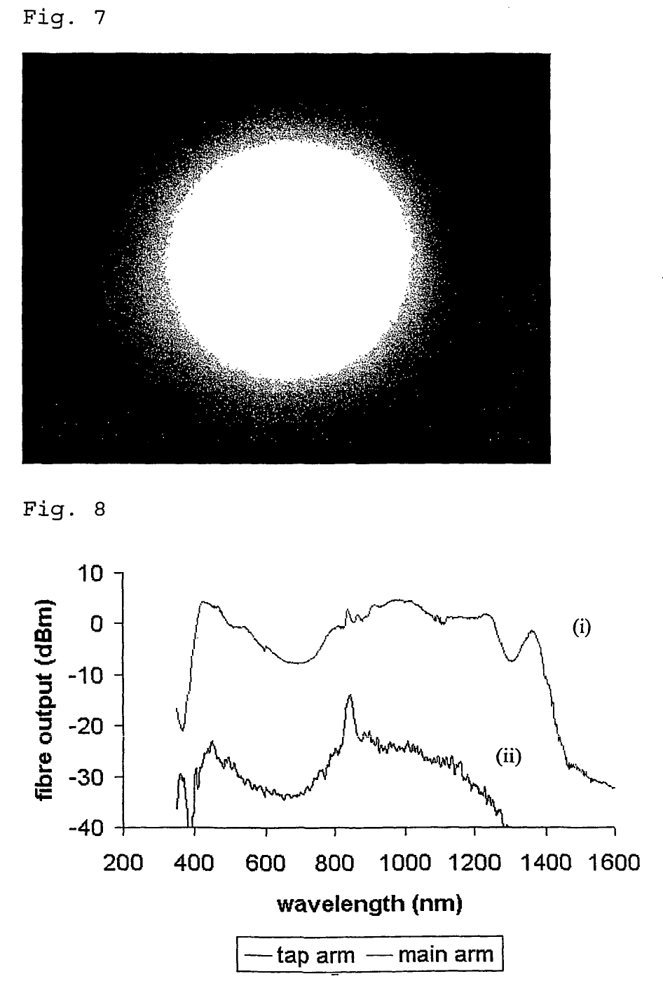

FIG. 7 shows the visible, far-field pattern of light output from a tapered fibre;

FIG. 8 shows output spectra from (i) the non-pretapered output arm and (ii) the pretapered output arm of a null coupler for input light in the non-pretapered input arm.

A conventional telecommunications optical fibre, having a cut-off wavelength of about 1250 nm and a numerical aperture of about 0.1, was heated and stretched in a flame, in a manner well known in the art, to produce tapered fibre 10. The fibre 10 (FIG. 1) includes non-tapered regions 20, waist 30, and transition regions 40. In cross-section, the fibre includes cladding 50 and core 60; the cladding 50 has a lower refractive index than the core 60, so that light is guided in the core of the non-tapered regions 20 by total internal reflection. Fibre 10 is tapered to have a particularly long and narrow waist, being uniformly of diameter 1.8 μm over a length of 90 mm. Tapering does. not introduce significant loss into the fibre.

In the waist 30, the core 60 is too small to guide light. Instead, light is guided in the waist 30 by total internal reflection at the boundary between cladding 50 and the surrounding air. Although silica has a small nonlinear susceptibility, the large refractive index step between fibre and air allows light to be confined to a very small area, increasing its intensity and promoting nonlinear effects such as self-phase modulation (SPM), four-wave mixing and Raman scattering. Such non-linear effects can result in a broadening of the spectrum of the propagating light, as is the case in supercontinuum generation.

The group-velocity dispersion (GVD) of silica is −84 ps nm⁻¹ km⁻¹ at 850 nm and so silica displays “normal” dispersion at that wavelength; that is, light of longer wavelengths travels faster than light of shorter wavelengths. Pulses will generally broaden in the presence of SPM and normal GVD, leading to a weakening of nonlinear effects as the peak power of the pulse drops. However, as can be seen in FIG. 2, the net GVD resulting from propagation through the waist of a tapered silica fibre can become positive at sufficiently small waist diameters. The taper waist then displays anomalous dispersion; light of shorter wavelengths travels faster than light of longer wavelengths. The anomalously dispersive effects of propagation in the narrow waist then counter the normally dispersive effects. Pulses may thus not broaden; rather, they can narrow significantly due to nonlinear effects (with a corresponding broadening of the pulse's spectrum) and nonlinear effects can thus increase further as a pulse propagates.

In our experiment, the source of pulses was a Ti:sapphire laser tuned to 850 nm. The pulses were of durations between 200 fs and 500 fs. The spectrum of the input light was a comb of frequencies resulting from the nature of the laser resonator.

For the 1.8 μm waist 30, a GVD of +122 ps nm⁻¹ and a nonlinear effective area of 1.21 μm² were calculated, corresponding to a nonlinear length of 0.6 mm and a dispersion length of 0.15 m. Significant SPM is therefore expected despite silica's strong dispersion; indeed, in our particular experimental set-up, the taper's anomalous dispersion also helped to counteract normal dispersion suffered as pulses propagated through an isolator, a launch objective and a length of non-tapered fibre.

The variation with wavelength of GVD in the waist of a tapered fibre is shown in FIG. 3, with the curve for bulk silica given for comparison. The silica curve only becomes positive for wavelengths greater than about 1300 nm, but the tapered fibres can display anomalous GVD at much lower wavelengths: for example, at about 650 nm for a 1.5 μm waist.

Output spectra obtained under similar conditions were found not to vary significantly for different tapered fibres. The output spectra in FIG. 4, obtained from 1550 nm telecomms fibre (cut-off wavelength of 1250 nm) and 850 nm fibre (cut-off wavelength 740 nm), are similar. The fibres had waist diameters of 1.8 μm and taper lengths of 90 mm and the average power was 310 mW and pulse energy 4.1 nJ (the powers and energies of the output pulses were measured, but the fibre exhibited little loss and it is believed that the powers and energies of the input pulses were very similar).

FIG. 5 shows output spectra for different waist diameters. FIG. 5 (i) is for a waist of 2.5 μm, with a pulse energy of 5.7 nJ, corresponding to 430 mW average power. A broad supercontinuum extends from about 500 nm to about 1400 nm. Although not shown in the figures, the output spectrum is expected to retain the comb-like frequency structure of the input light. FIG. 5(ii) shows a similar, slightly broader spectrum for a waist of 2 μm, with 5.0 nJ, 380 mW pulses; the spectrum extends from about 400 nm to about 1500 nm. Still broader, but less-flat, continua are obtained with waists of (FIG. 5(iii)) 1.8 μm (4.1 nJ pulses) and (FIG. 5(iv)) 1.5 μm (0.9 nJ pulses).

In FIG. 6, the curves have been shifted vertically for visibility; the peak powers of the three curves other than the input curve were roughly similar. The bandwidth of the generated continuum increases with increasing pulse power.

Intense visible and ultraviolet output was observed. Although the fibre, in its tapered and its non-tapered regions was multimode at those wavelengths, the output was in a single mode (FIG. 7).

There was no spectral broadening in non-tapered fibres.

The fibre's diameter could be varied along its length as it is tapered, enabling control of the distribution of intensity and dispersion along the device. That facility could be used, for example, to optimise the design of the device, for example in order to make the output spectrum flatter or broader.

Fibre 10 was mounted in a simple dust-proof housing and proved to be robust, surviving for several days without degradation and the fibre 10 also withstood impacts resulting from its being dropped from a height of about one meter. Fibre 10 is readily compatible with conventional fibre and free-space systems: core 60 is 9 μm across in the non-tapered region 20 and it is thus relatively easy to launch input light into the fibre.

Important immediate applications for this source of intense white light include spectroscopy with fine spatial resolution, ultrafast spectroscopy (pump-probe), frequency metrology, pulse compression and the measurement of dispersion.

A null fibre coupler has also been demonstrated using a fibre according to the invention. A null coupler is made by pre-tapering one fibre and fusing it to and tapering it with a non-pretapered fibre. FIG. 8 shows output spectra obtained from (i) the non-pretapered output arm and (ii) the pretapered output arm. The splitting ratio was 1.3%, the waist diameter was 2 μm and the length of the tapered region was 85 mm. 290 mW (3.8 nJ) was launched into the non-pretapered input arm. The tap arm (pretapered arm) spectrum is a good representation of the main arm spectrum.

It will be appreciated that various modifications and variations can be made to the designs described above.

1. A nonlinear optical device, comprising a source of input light having a first spectrum and an optical fibre arranged so that in use the light propagates through the fibre, the optical fibre comprising a tapered region including a waist, the waist having a diameter smaller than 10 μm for a length of more than 20 mm, wherein the propagating light is converted by nonlinear optical processes into output light having a spectrum different from the first spectrum.

2. A nonlinear optical device as claimed in claim 1, the waist having a diameter smaller than the diameter at which the net group-velocity dispersion D experienced by the input light is greater than −40 PS nm⁻¹ km⁻¹.

3. A nonlinear optical device as claimed in claim 1 or claim 2, the waist having a diameter smaller than the diameter at which the net group-velocity dispersion D that would be experienced by light at a wavelength within ±100 nm of the centre wavelength of the input light is anomalous.

4. A nonlinear optical device as claimed in any preceding claim, the waist having a diameter smaller than the diameter at which the net group-velocity dispersion D experienced by the input light is anomalous.

5. A nonlinear optical device as claimed in any preceding claim, in which the output spectrum has a width of at least 50 nm at 30 dB down from its maximum power.

6. A nonlinear optical device as claimed in any preceding claim, in which the waist has a length of more than 50 mm.

7. A nonlinear optical device as claimed in claim 6, in which the diameter of the waist is less than 7 μm.

8. A nonlinear optical device as claimed in any preceding claim, in which the waist is of substantially uniform diameter over its length.

9. A nonlinear optical device as claimed in any of claims 1 to 7, in which the diameter of the waist varies along its length.

10. A nonlinear optical device as claimed in claim 9, in which the diameter of waist does not exceed twice its minimum value over its length.

11. A nonlinear optical device as claimed in any preceding claim, in which the power of the input light is greater than 10 W.

12. A nonlinear optical device as claimed in any preceding claim, in which the input light is pulsed.

13. A nonlinear optical device as claimed in claim 12, in which the pulses are shorter than 10 ps.

14. A nonlinear optical device as claimed in any preceding claim, in which a source of input light is a laser.

15. A nonlinear optical device as claimed in claim 14, in which the laser is a Ti:sapphire laser.

16. A nonlinear optical device as claimed in any preceding claim, in which the fibre is a standard fibre.

17. A nonlinear optical device as claimed in any of claims 1 to 15, in which the fibre is microstructured.

18. A nonlinear optical device as claimed in any preceding claim, in which the fibre comprises fused silica.

19. A nonlinear optical device as claimed in any preceding claim, in which the fibre is single mode at a wavelength within the spectrum of the output light.

20. A nonlinear optical device as claimed in claim 19, in which the fibre is single mode at all wavelengths of the output light.

21. A nonlinear optical device as claimed in any preceding claim, in which the fibre is single mode at the centre wavelength of the input light.

22. A nonlinear optical device as claimed in claim 21, in which the fibre is single mode at all wavelengths of the input light.

23. A nonlinear optical device as claimed in any preceding claim, in which the fibre is surrounded, at least at the tapered region, by air.

24. A nonlinear optical device as claimed in any of claims 1 to 23, in which the fibre is surrounded, at least at the tapered region, by a fluid other than air.

25. A nonlinear optical device as claimed in any of claims 1 to 23, in which the fibre is surrounded, at least at the tapered region, by a vacuum.

26. A nonlinear optical device as claimed in any preceding claim, in which the fibre is surrounded, at least at the tapered region, with a fluid other than air.

27. A nonlinear optical device as claimed in any preceding claim, in which a second fibre is fused to the fibre.

28. A nonlinear optical device as claimed in claim 27, in which further fibres are fused to the fibre and/or the second fibre.

29. A nonlinear optical device as claimed in claim 27 or claim 28, in which the fused fibres form a fused coupler.

30. A nonlinear optical device as claimed in claim 29, in which the fibres are substantially identical so that the fused coupler is symmetric.

31. A nonlinear optical device as claimed in claim 29, in which at least one of the fibres is dissimilar from at least one other fibre in the coupler so that the coupler is asymmetric.

32. A nonlinear optical device as claimed in claim 31, in which the dissimilar fibre is so dissimilar that the coupler is a null coupler.

33. A nonlinear optical device as claimed in any of claims 27 to 32, in which an output of the coupler is used to monitor the coupler's behaviour in use.

34. A method of generating nonlinear optical effects comprising propagating input light having a first spectrum through an optical fibre, the optical fibre having a tapered region including a waist, the waist having a diameter smaller than 10 μm for a length of more than 20 mm, wherein the propagating light is converted by nonlinear optical processes into output light having a spectrum different from the first spectrum.

35. An optical fibre comprising a tapered region including a waist, the waist having a diameter smaller than 10 μm for a length of more than 20 mm, wherein, in use, the propagating light is converted by nonlinear optical processes into output light having a spectrum different from the first spectrum.

36. A method of supercontinuum generation, comprising propagating input light having a first spectrum through an optical fibre, the optical fibre having a tapered region including a waist, the waist having a diameter smaller than 10 μm, wherein the propagating light is converted by nonlinear optical processes into output light having an output spectrum having a width of at least 300 μm at 30 dB down from its maximum power.

37. A method of generating nonlinear optical effects substantially as herein described with reference to and as illustrated by the accompanying drawings.

38. A nonlinear optical device substantially as herein described with reference to and as illustrated by the accompanying drawings.
